(19) United States
(12) Patent Application Publication
(10) Pub. No.: US 2020/0250943 A1
(43) Pub. Date: Aug. 6, 2020

(54) Alarming Implementation Method, Device and System

(71) Applicant: ZTE CORPORATION, Shenzhen City, Guangdong Province (CN)

(72) Inventors: Xiaoliang ZHANG, Shenzhen (CN); Hui LIU, Shenzhen (CN)

(21) Appl. No.: 15/769,747

(22) PCT Filed: Mar. 21, 2016
(86) PCT No.: PCT/CN2016/076863

§ 371 Date: Apr. 20, 2018

(30) Foreign Application Priority Data
Oct. 22, 2015 (CN) 201510694930.6

(51) Int. Cl. G08B 13/14; H04W 4/02

(52) U.S. Cl. CPC G08B 13/1427; G08B 21/0269; H04W 4/027

(57) ABSTRACT

Provided are an alarming implementation method and device. The method includes: acquiring an acceleration of a mobile terminal in a first coordinate system, and acquiring an included angle between the first coordinate system and a second coordinate system; calculating a location of the mobile terminal in the second coordinate system according to the acquired acceleration and included angle; and when determining that the calculated location is out of a safety area, making an alarm or sending alarm information to a system side apparatus.

### CROSS REFERENCE

The present application is a U.S. National Phase Entry of International PCT Application No. PCT/CN2016/076863 having an international filing date of Mar. 21, 2016, which claims priority to Chinese Patent Application No. 201510694930.6, filed on Oct. 22, 2015. The present application claims priority and the benefit of the above-identified applications and the above-identified applications are incorporated by reference herein in their entirety.

### TECHNICAL FIELD

The present document relates to, but not limited to, a terminal technology, and more particularly to an alarming implementation method, device and system.

### BACKGROUND

A related alarming implementation method generally includes the steps as follows:

a Global Positioning System (GPS) or a Location Based Service (LBS) positioning technology is adopted to acquire its own current location, and an alarm is made when the acquired location is out of a preset location range.

In the related alarming implementation method, a GPS signal is very poor indoors, and the LBS has a low positioning accuracy indoors. But in practice, positioning indoors is often required for an alarming implementation. For example, for exhibits in an exhibition hall, it is required to judge whether the exhibits are taken away from the exhibition hall. If so, it is required to make an alarm. Therefore, a false alarm may be made or there is no alarm if an alarm is required. The user experience is low.

### SUMMARY

The following is a brief introduction for a subject described herein in detail. The brief introduction is not intended to restrict the scope of protection of claims.

Embodiments of the present disclosure provide an alarming implementation method, device and system, capable of improving the alarming accuracy, thereby improving the user experience.

An embodiment of the present disclosure provides an alarming implementation method, including:

acquiring an acceleration of a mobile terminal in a first coordinate system, and acquiring an included angle between the first coordinate system and a second coordinate system;

calculating a location of the mobile terminal in the second coordinate system according to the acquired acceleration and included angle; and

when determining that the calculated location is out of a safety area, making an alarm or sending alarm information to a system side apparatus.

In an exemplary embodiment, before the above-mentioned method, the method further includes:

presetting the safety area.

In an exemplary embodiment, presetting the safety area includes:

acquiring at least three locations of the mobile terminal in the second coordinate system in advance, and connecting the acquired locations to form a closed area as the safety area.

In an exemplary embodiment, acquiring the included angle between the first coordinate system and a second coordinate system includes:

acquiring an included angle between an n^{th} time point and an (n−1)^{th} time point of the first coordinate system, where n is an integer greater than or equal to 1; and

calculating the included angle between the first coordinate system and the second coordinate system according to the included angle between the n^{th} time point and the (n−1)^{th} time point of the first coordinate system.

In an exemplary embodiment, calculating an included angle between the first coordinate system and the second coordinate system according to the included angle between the n^{th} time point and the (n−1)^{th} time point of the first coordinate system includes:

calculating an included angle between an X axis of the first coordinate system and an X axis of the second coordinate system according to a formula αₙ=αₙ₋₁+αₙ₋₂+Λ+α₁; and

calculating an included angle between a Y axis of the first coordinate system and a Y axis of the second coordinate system according to a formula βₙ=βₙ₋₁+βₙ₋₂+Λ+β₁.

Herein, αₙ is an included angle between the X axis of the first coordinate system and the X axis of the second coordinate system at an n^{th} time point, αₙ₋₁ is an included angle between the n^{th} time point and an (n−1)^{th} time point of the X axis of the first coordinate system, αₙ₋₂ is an included angle between the (n−1)^{th} time point and an (n−2)^{th} time point of the X axis of the first coordinate system, and α₁ is an included angle between the X axis of the first coordinate system and the X axis of the second coordinate system at an initial time point; and βₙ is an included angle between the Y axis of the first coordinate system and the Y axis of the second coordinate system at the n^{th} time point, βₙ₋₁ is an included angle between the n^{th} time point and the (n−1)^{th} time point of the Y axis of the first coordinate system, βₙ₋₂ is an included angle between the (n−1)^{th} time point and the (n−2)^{th} time point of the Y axis of the first coordinate system, and β₁ is an included angle between the Y axis of the first coordinate system and the Y axis of the second coordinate system at the initial time point.

In an exemplary embodiment, calculating the location of the mobile terminal in the second coordinate system according to the acquired acceleration and included angle includes:

calculating a location of the mobile terminal in the X axis of the second coordinate system according to formula xₙ=xₙ₋₁+(vx′ₙ₋₁Δt+½axₙ₋₁Δt²)cos αₙ; and

calculating location of the mobile terminal in the Y axis of the second coordinate system according to formula yₙ=yₙ₋₁+(vy′ₙ₋₁Δt+½ayₙ₋₁Δt²)cos βₙ.

Herein, vx′ₙ₋₁ is calculated according to a formula vx′ₙ₋₁=vx′ₙ₋₂+axₙ₋₂Δt, and vy′ₙ₋₁ is calculated according to a formula vy′ₙ₋₁=vy′ₙ₋₂+ayₙ₋₂Δt.

Herein, xₙ is a location of the mobile terminal in the X axis of the second coordinate system at an n^{th} time point, xₙ₋₁ is a location of the mobile terminal in the X axis of the second coordinate system at an (n−1)^{th} time point, vx′ₙ₋₁ is a velocity of the mobile terminal in the X axis of the first coordinate system at the (n−1)^{th} time point, Δt is a time interval between the n^{th} time point and the (n−1)^{th} time point, axₙ₋₁ is an acceleration of the mobile terminal in the X axis of the first coordinate system at the (n−1)^{th} time point, αₙ is an included angle between the X axis of the first coordinate system and the X axis of the second coordinate system at an n^{th} time point, vx′ₙ₋₂ is a velocity of the mobile terminal in the X axis of the first coordinate system at an (n−2)^{th} time point, axₙ₋₂ is an acceleration of the mobile terminal in the X axis of the first coordinate system at an (n−2)^{th} time point, yₙ is a location of the mobile terminal in the Y axis of the second coordinate system at the n^{th} time point, yₙ₋₁ is a location of the mobile terminal in the Y axis of the second coordinate system at the (n−1)^{th} time point, vy′ₙ₋₁ is a velocity of the mobile terminal in the Y axis of the first coordinate system at the (n−1)^{th} time point, ayₙ₋₁ is an acceleration of the mobile terminal in the Y axis of the first coordinate system at the (n−1)^{th} time point, βₙ is an included angle between the Y axis of the first coordinate system and the Y axis of the second coordinate system at the n^{th} time point, vy′ₙ₋₂ is a velocity of the mobile terminal in the Y axis of the first coordinate system at the (n−2)^{th} time point, and ayₙ₋₂ is an acceleration of the mobile terminal in the Y axis of the first coordinate system at the (n−2)^{th} time point.

An embodiment of the present disclosure also provides a computer-readable storage medium, which stores a computer-executable instruction, and the computer-executable instruction is used to execute any one of the methods described above.

An embodiment of the present disclosure also provides an alarming implementation device, including an acquisition module, a calculation module and an alarming module.

The acquisition module is configured to acquire an acceleration of a mobile terminal in a first coordinate system, and acquire an included angle between the first coordinate system and a second coordinate system.

The calculation module is configured to calculate a location of the mobile terminal in the second coordinate system according to the acquired acceleration and included angle.

The alarming module is configured to make an alarm or send alarm information to a system side apparatus when determining that the calculated location is out of a safety area.

In an exemplary embodiment, the device further includes:

a setting module, configured to preset the safety area.

In an exemplary embodiment, the setting module is configured to:

acquire at least three locations of the mobile terminal in the second coordinate system in advance, and connect the acquired locations to form a closed area as the safety area.

In an exemplary embodiment, the acquisition module is configured to:

acquire an acceleration of the mobile terminal in the first coordinate system, and acquire an included angle between an n^{th} time point and an (n−1)^{th} time point of the first coordinate system, where n is an integer greater than or equal to 1; and

calculate the included angle between the first coordinate system and the second coordinate system according to the included angle between the n^{th} time point and the (n−1)^{th} time point of the first coordinate system.

In an exemplary embodiment, the acquisition module is configured to:

acquire the acceleration of the mobile terminal in the first coordinate system, and acquire an included angle between an n^{th} time point and an (n−1)^{th} time point of the first coordinate system, where n is an integer greater than or equal to 1;

calculate an included angle between an X axis of the first coordinate system and an X axis of the second coordinate system according to a formula αₙ=αₙ₋₁+αₙ₋₂+Λ+α₁; and

calculate an included angle between a Y axis of the first coordinate system and a Y axis of the second coordinate system according to a formula βₙ=βₙ₋₁+βₙ₋₂+Λ+β₁.

Herein, αₙis an included angle between the X axis of the first coordinate system and the X axis of the second coordinate system at an n^{th} time point, αₙ₋₁ is an included angle between the n^{th} time point and an (n−1)^{th} time point of the X axis of the first coordinate system, αₙ₋₂ is an included angle between the (n−1)^{th} time point and an (n−2)^{th} time point of the X axis of the first coordinate system, and α₁ is an included angle between the X axis of the first coordinate system and the X axis of the second coordinate system at an initial time point; and βₙ is an included angle between the Y axis of the first coordinate system and the Y axis of the second coordinate system at an n^{th} time point, βₙ₋₁ is an included angle between the n^{th} time point and an (n−1)^{th} time point of the Y axis of the first coordinate system, βₙ₋₂ is an included angle between the (n−1)^{th} time point and an (n−2)^{th} time point of the Y axis of the first coordinate system, and β₁ is an included angle between the Y axis of the first coordinate system and the Y axis of the second coordinate system at the initial time point.

In an exemplary embodiment, the calculation module is configured to:

calculate a location of the mobile terminal in the X axis of the second coordinate system according to a formula xₙ=xₙ₋₁+(vx′ₙ₋₁Δt+½axₙ₋₁Δt²)cos αₙ; and

calculate a location of the mobile terminal in the Y axis of the second coordinate system according to a formula yₙ=yₙ₋₁+(vy′ₙ₋₁Δt+½ayₙ₋₁Δt²)cos βₙ.

Herein, vx′ₙ₋₁ is calculated according to a formula vx′ₙ₋₁=vx′ₙ₋₂+axₙ₋₂Δt, and vy′ₙ₋₁ is calculated according to a formula vy′ₙ₋₁=vy′ₙ₋₂+ayₙ₋₂Δt.

Herein, xₙ is a location of the mobile terminal in the X axis of the second coordinate system at an n^{th} time point, xₙ₋₁ is a location of the mobile terminal in the X axis of the second coordinate system at an (n−1)^{th} time point, vx′ₙ₋₁ is a velocity of the mobile terminal in the X axis of the first coordinate system at the (n−1)^{th} time point, Δt is a time interval between the n^{th} time point and the (n−1)^{th} time point, axₙ₋₁ is an acceleration of the mobile terminal in the X axis of the first coordinate system at the (n−1)^{th} time point, αₙ is an included angle between the X axis of the first coordinate system and the X axis of the second coordinate system at the n^{th} time point, vx′ₙ₋₂ is a velocity of the mobile terminal in the X axis of the first coordinate system at an (n−2)^{th} time point, axₙ₋₂ is an acceleration of the mobile terminal in the X axis of the first coordinate system at the (n−2)^{th} time point, yₙ is a location of the mobile terminal in the Y axis of the second coordinate system at the n^{th} time point, yₙ₋₁ is a location of the mobile terminal in the Y axis of the second coordinate system at the (n−1)^{th} time point, vy′ₙ₋₁ is a velocity of the mobile terminal in the Y axis of the first coordinate system at the (n−1)^{th} time point, ayₙ₋₁ is an acceleration of the mobile terminal in the Y axis of the first coordinate system at the (n−1)^{th} time point, βₙ is an included angle between the Y axis of the first coordinate system and the Y axis of the second coordinate system at the n^{th} time point, vy′ₙ₋₂ is a velocity of the mobile terminal in the Y axis of the first coordinate system at the (n−2)^{th} time point, and ayₙ₋₂ is an acceleration of the mobile terminal in the Y axis of the first coordinate system at the (n−2)^{th} time point.

An embodiment of the present disclosure also provides an alarming implementation system, including a mobile terminal and a system side apparatus.

The mobile terminal is configured to acquire an acceleration of a mobile terminal in a first coordinate system, and acquire an included angle between the first coordinate system and a second coordinate system; calculate a location of the mobile terminal in the second coordinate system according to the acquired acceleration and included angle; and make an alarm or send alarm information to a system side apparatus when determining that the calculated location is out of a safety area.

The system side apparatus is configured to receive the alarm information from the mobile terminal, and make an alarm.

In an exemplary embodiment, the mobile terminal is further configured to:

preset the safety area.

Compared with the related art, the technical solution of embodiments of the present disclosure includes: acquiring an acceleration of a mobile terminal in a first coordinate system, and acquiring an included angle between the first coordinate system and a second coordinate system; calculating a location of the mobile terminal in the second coordinate system according to the acquired acceleration and included angle; and when determining that the calculated location is out of a safety area, making an alarm or sending alarm information to a system side apparatus. By means of the solutions of embodiments of the present disclosure, the location of the mobile terminal in the second coordinate system is calculated by using the acceleration of the mobile terminal in the first coordinate system and the included angle between the first coordinate system and the second coordinate system. Thus, indoor positioning is achieved without the use of an external signal, and the positioning accuracy is high, and the alarming accuracy is improved, thereby improving the user experience.

After the drawings and the detailed descriptions are read and understood, other aspects may be understood.

### BRIEF DESCRIPTION OF DRAWINGS

FIG. 1 is a flowchart of an alarming implementation method according to an embodiment of the present disclosure.

FIG. 2 is a schematic structure composition diagram of an alarming implementation device according to an embodiment of the present disclosure.

FIG. 3 is a schematic structure composition diagram of an alarming implementation system according to an embodiment of the present disclosure.

### DETAILED DESCRIPTION

For convenience of understanding of those skilled in the art, the present disclosure is further described below with reference to the accompanying drawings, and the descriptions cannot be used to limit the protection scope of the present disclosure. It should be noted that the embodiments in the present application and various implementations in the embodiments can be combined with each other when there is no conflicts.

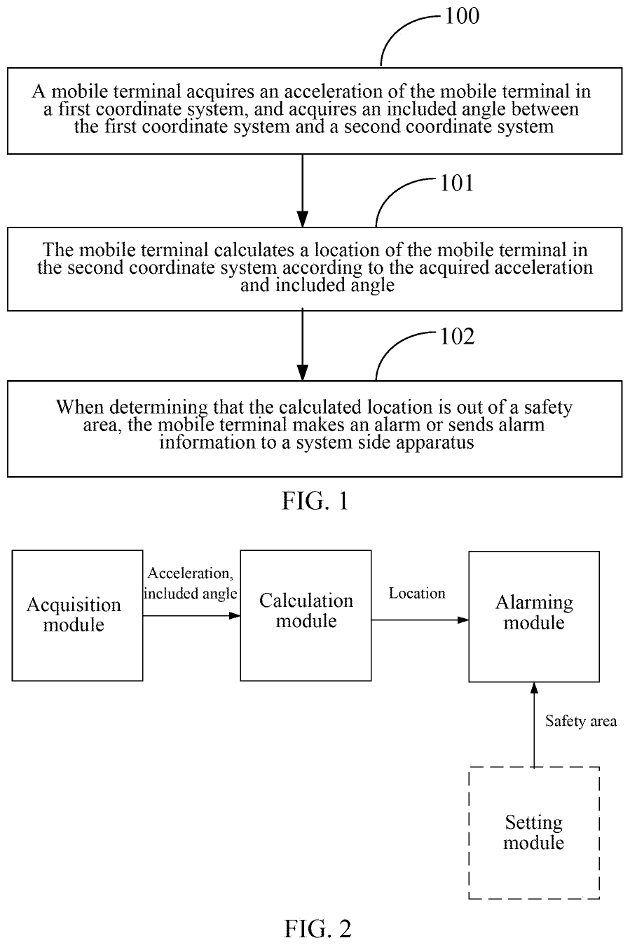

Referring to FIG. 1, an embodiment of the present disclosure provides an alarming implementation method, and a mobile terminal presets a safety area.

Herein, presetting the safety area includes:

acquiring at least three locations in the second coordinate system in advance, and connecting the acquired locations to form a closed area as the safety area.

Herein, the at least three locations in the second coordinate system may be acquired by formulas (1) to (4), that is, after a mobile terminal starts to run, the real-time locations of the mobile terminal in the second coordinate system are calculated by using formulas (1) to (4) at regular time. A user may set a safety area through an interactive interface of the mobile terminal, that is, after the user carries the mobile terminal to a certain location, the user stops moving and the mobile terminal records a location in the second coordinate system, and then, the mobile terminal is carried to another location and the user stops moving, and so on, until all the locations are acquired, and these acquired locations are connected in the order of acquisition to form a closed area.

The method includes the steps as follows.

In step 100, a mobile terminal acquires an acceleration of the mobile terminal in a first coordinate system, and acquires an included angle between the first coordinate system and a second coordinate system.

In the present step, an acceleration sensor may be used to acquire the acceleration of the mobile terminal in the first coordinate system, of which the specific implementation belongs to the known technology of those skilled in the art, and is not used to limit the protection scope of the present disclosure, and will not be repeated here. The embodiment of the present disclosure emphasizes that positioning is achieved according to the acquired acceleration and included angle, and the positioning accuracy is improved, thereby improving the user experience.

In the present step, the first coordinate system is a coordinate system where the acceleration sensor is located, and the second coordinate system is a preset coordinate system, which may be arbitrarily set.

In the present step, acquiring an included angle between the first coordinate system and a second coordinate system includes:

acquiring an included angle between an n^{th} time point and an (n−1)^{th} time point of the first coordinate system, where n is an integer greater than or equal to 1; and calculating an included angle between the first coordinate system and the second coordinate system according to the included angle between the n^{th} time point and the (n−1)^{th} time point of the first coordinate system.

Herein, a gyroscope may be used to acquire the included angle between the n^{th} time point and the (n−1)^{th} time point of the first coordinate system, of which the specific implementation belongs the known technology of those skilled in the art, and is not used to limit the protection scope of the present disclosure, and will not be repeated here. The embodiment of the present disclosure emphasizes that positioning is achieved according to the acquired acceleration and included angle, and the positioning accuracy is improved, thereby improving the user experience.

Herein, the calculating an included angle between the first coordinate system and the second coordinate system according to the included angle between the n^{th} time point and the (n−1)^{th} time point of the first coordinate system includes:

calculating an included angle between an X axis of the first coordinate system and an X axis of the second coordinate system according to formula (1); and calculating an included angle between a Y axis of the first coordinate system and a Y axis of the second coordinate system according to formula (2).

αₙ=αₙ₋₁+αₙ₋₂+Λ+α₁ (1)

βₙ=βₙ₋₁+βₙ₋₂+Λ+β₁ (2)

Herein, αₙ is an included angle between the X axis of the first coordinate system and the X axis of the second coordinate system at an n^{th} time point, αₙ₋₁ is an included angle between the n^{th} time point and an (n−1)^{th} time point of the X axis of the first coordinate system, αₙ₋₂ is an included angle between the (n−1)^{th} time point and an (n−2)^{th} time point of the X axis of the first coordinate system, and α₁ is an included angle between the X axis of the first coordinate system and the X axis of the second coordinate system at an initial time point; and βₙ is an included angle between the Y axis of the first coordinate system and the Y axis of the second coordinate system at an n^{th} time point, βₙ₋₁ is an included angle between the n^{th} time point and an (n−1)^{th} time point of the Y axis of the first coordinate system, βₙ₋₂ is an included angle between the (n−1)^{th} time point and an (n−2)^{th} time point of the Y axis of the first coordinate system, and β₁ an included angle between the Y axis of the first coordinate system and the Y axis of the second coordinate system at an initial time point.

Herein, at initial time, both α₁ and β₁ may be 0, that is, the first coordinate system and the second coordinate system coincide at the initial time.

In step 101, the mobile terminal calculates the location of the mobile terminal in the second coordinate system according to the acquired acceleration and included angle, and the step includes:

calculating the location of the mobile terminal in the X axis of the second coordinate system according to formula (3); and calculating the location of the mobile terminal in the X axis of the second coordinate system according to formula (4).

xₙ=xₙ₋₁+(vx′ₙ₋₁Δt+½axₙ₋₁Δt²)cos αₙ (3)

yₙ=yₙ₋₁+(vy′ₙ₋₁Δt+½ayₙ₋₁Δt²)cos βₙ (4)

Herein, vx′ₙ₋₁ is calculated according to a formula vx′ₙ₋₁=vx′ₙ₋₂+axₙ₋₂Δt, and vy′ₙ₋₁ is is calculated according to formula vy′ₙ₋₁=vy′ₙ₋₂+ayₙ₋₂Δt.

Herein, xₙ is a location of the mobile terminal in the X axis of the second coordinate system at an n^{th} time point, xₙ₋₁ is a location of the mobile terminal in the X axis of the second coordinate system at an (n−1)^{th} time point, vx′ₙ₋₁ is a velocity of the mobile terminal in the X axis of the first coordinate system at the (n−1)^{th} time point, Δt is a time interval between the n^{th} time point and the (n−1)^{th} time point, axₙ₋₁ is an acceleration of the mobile terminal in the X axis of the first coordinate system at the (n−1)^{th} time point, αₙ is an included angle between the X axis of the first coordinate system and the X axis of the second coordinate system at the n^{th} time point, vx′ₙ₋₂ is a velocity of the mobile terminal in the X axis of the first coordinate system at an (n−2)^{th} time point, axₙ₋₂ is an acceleration of the mobile terminal in the X axis of the first coordinate system at the (n−2)^{th} time point, yₙ is a location of the mobile terminal in the Y axis of the second coordinate system at the n^{th} time point, yₙ₋₁ is a location of the mobile terminal in the Y axis of the second coordinate system at the (n−1)^{th} time point, vy′ₙ₋₁ is a velocity of the mobile terminal in the Y axis of the first coordinate system at the (n−1)^{th} time point, ayₙ₋₁ is an acceleration of the mobile terminal in the Y axis of the first coordinate system at the (n−1)^{th} time point, βₙ is an included angle between the Y axis of the first coordinate system and the Y axis of the second coordinate system at the n^{th} time point, vy′ₙ₋₂ is a velocity of the mobile terminal in the Y axis of the first coordinate system at the (n−2)^{th} time point, and ayₙ₋₂ is an acceleration of the mobile terminal in the Y axis of the first coordinate system at the (n−2)^{th} time point.

In step 102, when determining that the calculated location is out of a safety area, the mobile terminal makes an alarm or sends alarm information to a system side apparatus.

In the present step, when the mobile terminal determines that the calculated location is not out of a safety area, this flow is ended.

Herein, determining that the calculated location is not out of a safety area includes the following operations.

The Y-axis location(s) of an intersection point(s), at which a straight line including the calculated location and being parallel with the Y axis of the second coordinate system intersects with the boundary of the safety area, is calculated. When it is determined that there is one calculated Y-axis location of the intersection point(s), the Y-axis location of the intersection point(s) is equal to the Y-axis location of the calculated location; or, when it is determined that there are two calculated Y-axis locations of the intersection points, the Y-axis location of the calculated location is greater than or equal to a minimum value of the calculated Y-axis locations of the intersection points and is smaller than or equal to a maximum value of the calculated Y-axis locations of the intersection points; or, when it is determined that there are two calculated Y-axis locations of the intersection points, the intersection points are both vertexes of the safety area, the Y-axis location of the calculated location is equal to one of the calculated Y-axis locations of the intersection points.

Or, the X-axis location(s) of an intersection point(s), at which a straight line including the calculated location and being parallel with the X axis of the second coordinate system intersects with the boundary of the safety area, is calculated. When it is determined that there is one calculated X-axis location of the intersection point(s), the X-axis location of the intersection point(s) is equal to the X-axis location of the calculated location; or, when it is determined that there are two calculated X-axis locations of the intersection points, the X-axis location of the calculated location is greater than or equal to a minimum value of the calculated X-axis locations of the intersection points and is smaller than or equal to a maximum value of the calculated X-axis locations of the intersection points; or, when it is determined that there are two calculated X-axis locations of the intersection points, the intersection points are both vertexes of the safety area, and the X-axis location of the calculated location is equal to one of the calculated X-axis locations of the intersection points.

In the present step, determining that the calculated location is out of a safety area includes the following operations.

The Y-axis location(s) of an intersection point(s), at which a straight line including the calculated location and being parallel with the Y axis of the second coordinate system intersects with the boundary of the safety area, is calculated. When it is determined that there is one calculated Y-axis location of the intersection point(s), the Y-axis location of the intersection point(s) is not equal to the Y-axis location of the calculated location; or, when it is determined that there are two calculated Y-axis locations of the intersection points, the Y-axis location of the calculated location is greater than a maximum value of the calculated Y-axis locations of the intersection points or smaller than a minimum value of the calculated Y-axis locations of the intersection points; or, when it is determined that there are two calculated Y-axis locations of the intersection points, the intersection points are both vertexes of the safety area, the Y-axis location of the calculated location is not equal to any one of the calculated Y-axis locations of the intersection points.

Or, the X-axis location(s) of an intersection point(s), at which a straight line including the calculated location and being parallel with the X axis of the second coordinate system intersects with the boundary of the safety area, is calculated. when it is determined that there is one calculated X-axis location of the intersection point(s), the X-axis location of the intersection point(s) is not equal to the X-axis location of the calculated location; or, when it is determined that there are two calculated X-axis locations of the intersection points, the X-axis location of the calculated location is greater than a maximum value of the calculated X-axis locations of the intersection points or smaller than a minimum value of the calculated X-axis locations of the intersection points; or, when it is determined that there are two calculated X-axis locations of the intersection points, the intersection points are both vertexes of the safety area, the X-axis location of the calculated location is not equal to any one of the calculated X-axis locations of the intersection points.

By analogy, when there are at least three X-axis or Y-axis locations of the intersection points, those skilled in the art may easily conclude, from each situation, which situations belong to the situation that the calculated location is out of the safety area, and which situations belong to the situation that the calculated location is not out of the safety area.

Herein, the Y-axis location(s) of an intersection point(s), at which a straight line including the calculated location and being parallel with the Y axis of the second coordinate system intersects with the boundary of the safety area, may be calculated according to the location of each vertex in the safety area, of which the specific implementation belongs to the known technology of those skilled in the art, and is not used to limit the protection scope of the present disclosure, and will not be repeated here.

Herein, the X-axis location(s) of an intersection point(s), at which a straight line including the calculated location and being parallel with the X axis of the second coordinate system intersects with the boundary of the safety area, may be calculated according to the location of each vertex in the safety area, of which the specific implementation belongs to the known technology of those skilled in the art, and is not used to limit the protection scope of the present disclosure, and will not be repeated here.

In the present step, an alarm may be made by means of sound or vibration, of which the specific implementation belongs to the known technology of those skilled in the art, and is not used to limit the protection scope of the present disclosure, and will not be repeated here.

In the present step, after receiving the alarm information, the system side apparatus makes an alarm.

By means of the solutions of embodiments of the present disclosure, the location of the mobile terminal in the second coordinate system is calculated by using the acceleration of the mobile terminal in the first coordinate system and the included angle between the first coordinate system and the second coordinate system. Thus, indoor positioning is achieved without the use of an external signal, and the positioning accuracy is high, and the alarming accuracy is improved, thereby improving the user experience.

An embodiment of the present disclosure also provides a computer-readable storage medium, which stores a computer-executable instruction. The computer-executable instruction is used to execute any one of the methods described above.

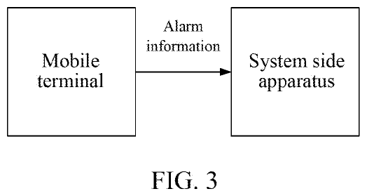

Referring to FIG. 2, an embodiment of the present disclosure also provides an alarming implementation device, arranged in a mobile terminal. The device includes an acquisition module, a calculation module and an alarming module.

The acquisition module is configured to acquire an acceleration of a mobile terminal in a first coordinate system, and acquire an included angle between the first coordinate system and a second coordinate system.

The calculation module is configured to calculate the location of the mobile terminal in the second coordinate system according to the acquired acceleration and included angle.

The alarming module is configured to make an alarm or send alarm information to a system side apparatus when determining that the calculated location is out of a safety area.

Herein, the acquisition module may acquire the acceleration in the first coordinate system by using an acceleration sensor.

The device of an embodiment of the present disclosure further includes:

a setting module, configured to preset the safety area.

In the device of an embodiment of the present disclosure, the setting module is configured to:

acquire at least three locations of the mobile terminal in the second coordinate system in advance, and connect the acquired locations to form a closed area as the safety area.

In the device of an embodiment of the present disclosure, the acquisition module is configured to:

acquire an acceleration of the mobile terminal in the first coordinate system, and acquire an included angle between an n^{th} time point and an (n−1)^{th} time point of the first coordinate system, where n is an integer greater than or equal to 1; and

calculate an included angle between the first coordinate system and the second coordinate system according to the included angle between the n^{th} time point and the (n−1)^{th} time point of the first coordinate system.

Herein, the acquisition module may acquire the included angle between the n^{th} time point and the (n−1)^{th} time point of the first coordinate system by using a gyroscope.

In the device of an embodiment of the present disclosure, the acquisition module is configured to:

acquire an acceleration of the mobile terminal in the first coordinate system, and acquire an included angle between an n^{th} time point and an (n−1)^{th} time point of the first coordinate system, where n is an integer greater than or equal to 1;

calculate an included angle between an X axis of the first coordinate system and an X axis of the second coordinate system according to a formula αₙ=αₙ₋₁+αₙ₋₂+Λ+α₁; and

calculate an included angle between a Y axis of the first coordinate system and a Y axis of the second coordinate system according to a formula βₙ=βₙ₋₁+βₙ₋₂+Λ+β₁.

Herein, αₙ is an included angle between the X axis of the first coordinate system and the X axis of the second coordinate system at an n^{th} time point, αₙ₋₁ is an included angle between the n^{th} time point and an (n−1)^{th} time point of the X axis of the first coordinate system, αₙ₋₂ is an included angle between the (n−1)^{th} time point and an (n−2)^{th} time point of the X axis of the first coordinate system, and α₁ is an included angle between the X axis of the first coordinate system and the X axis of the second coordinate system at an initial time point; and βₙ is an included angle between the Y axis of the first coordinate system and the Y axis of the second coordinate system at an n^{th} time point, βₙ₋₁ is an included angle between the n^{th} time point and an (n−1)^{th} time point of the Y axis of the first coordinate system, βₙ₋₂ is an included angle between the (n−1)^{th} time point and an (n−2)^{th} time point of the Y axis of the first coordinate system, and β₁ is an included angle between the Y axis of the first coordinate system and the Y axis of the second coordinate system at the initial time point.

In the device of an embodiment of the present disclosure, the calculation module is configured to:

calculate the location of the mobile terminal in the X axis of the second coordinate system according to a formula xₙ=xₙ₋₁+(vx′ₙ₋₁Δt+½axₙ₋₁Δt²)cos αₙ; and

calculate the location of the mobile terminal in the Y axis of the second coordinate system according to a formula yₙ=yₙ₋₁+(vy′ₙ₋₁Δt+½ayₙ₋₁Δt²)cos βₙ.

Herein, vx′ₙ₋₁ is calculated according to a formula vx′ₙ₋₁=vx′ₙ₋₂+axₙ₋₂Δt, and vy′ₙ₋₁ is calculated according to a formula vy′ₙ₋₁=vy′ₙ₋₂+ayₙ₋₂Δt.

Herein, xₙ is a location of the mobile terminal in the X axis of the second coordinate system at an n^{th} time point, xₙ₋₁ is a location of the mobile terminal in the X axis of the second coordinate system at an (n−1)^{th} time point, vx′ₙ₋₁ is a velocity of the mobile terminal in the X axis of the first coordinate system at an (n−1)^{th} time point, Δt is a time interval between an n^{th} time point and an (n−1)^{th} time point, axₙ₋₁ is an acceleration of the mobile terminal in the X axis of the first coordinate system at an (n−1)^{th} time point, αₙ is an included angle between the X axis of the first coordinate system and the X axis of the second coordinate system at an n^{th} time point, vx′ₙ₋₂ is a velocity of the mobile terminal in the X axis of the first coordinate system at an (n−2)^{th} time point, axₙ₋₂ is an acceleration of the mobile terminal in the X axis of the first coordinate system at an (n−2)^{th} time point, yₙ is a location of the mobile terminal in the Y axis of the second coordinate system at an n^{th} time point, yₙ₋₁ is a location of the mobile terminal in the Y axis of the second coordinate system at an (n−1)^{th} time point, vy′ₙ₋₁ is a velocity of the mobile terminal in the Y axis of the first coordinate system at an (n−1)^{th} time point, ayₙ₋₁ is an acceleration of the mobile terminal in the Y axis of the first coordinate system at an (n−1)^{th} time point, βₙ is an included angle between the Y axis of the first coordinate system and the Y axis of the second coordinate system at an n^{th} time point, vy′ₙ₋₂ is a velocity of the mobile terminal in the Y axis of the first coordinate system at an (n−2)^{th} time point, and ayₙ₋₂ is an acceleration of the mobile terminal in the Y axis of the first coordinate system at an (n−2)^{th} time point.

Referring to FIG. 3, an embodiment of the present disclosure also provides an alarming implementation system, including a mobile terminal and a system side apparatus.

The mobile terminal is configured to acquire an acceleration of a mobile terminal in a first coordinate system, and acquire an included angle between the first coordinate system and a second coordinate system; calculate a location of the mobile terminal in the second coordinate system according to the acquired acceleration and included angle; and send alarm information to a system side apparatus when determining that the calculated location is out of a safety area.

The system side apparatus is configured to receive the alarm information from the mobile terminal, and make an alarm.

In the system of an embodiment of the present disclosure, the mobile terminal is further configured to preset the safety area.

Those of ordinary skill in the art may understand that all or some steps in the above-mentioned methods can be implemented by instructing relevant hardware (such as a processor) via a program, and the program may be stored in a computer-readable storage medium such as a read-only memory, a magnetic disk or an optical disk or the like. In an exemplary embodiment, all or some steps in the above-mentioned embodiments may be implemented by using one or more integrated circuits. Correspondingly, various modules/units in the above-mentioned embodiments may be implemented in a form of hardware, for example, the corresponding functions are implemented by means of an integrated circuit. Or the various modules/units in the above-mentioned embodiments may be implemented in a form of software function module, for example, the corresponding functions are implemented by executing a program/instruction stored in a storage via a processor. The present disclosure is not limited to combinations of any specific hardware and software.

It should be noted that the above-mentioned embodiments are only intended to be easily understood by those skilled in the art, and not used to limit the protection scope of the present disclosure. Any obvious replacements, improvements and the like made on the present disclosure by those skilled in the art without departing from the inventive concept of the present disclosure fall within the protection scope of the present disclosure.

### INDUSTRIAL APPLICABILITY

The above technical solution improves the alarming accuracy, thereby improving the user experience.

What is claimed is:

1. An alarming implementation method, comprising:
acquiring an acceleration of a mobile terminal in a first coordinate system, and acquiring an included angle between the first coordinate system and a second coordinate system;
calculating a location of the mobile terminal in the second coordinate system according to the acquired acceleration and included angle; and
when determining that the calculated location is out of a safety area, making an alarm or sending alarm information to a system side apparatus.

2. The method according to claim 1, before the method, further comprising:
presetting the safety area.

3. The method according to claim 2, wherein the presetting the safety area comprises:
acquiring at least three locations of the mobile terminal in the second coordinate system in advance, and connecting the acquired locations to form a closed area as the safety area.

4. The method according to claim 1, wherein the acquiring an included angle between the first coordinate system and a second coordinate system comprises:
acquiring an included angle between an n^{th} time point and an (n−1)^{th} time point of the first coordinate system, where n is an integer greater than or equal to 1; and
calculating the included angle between the first coordinate system and the second coordinate system according to the included angle between the n^{th} time point and the (n−1)^{th} time point of the first coordinate system.

5. The method according to claim 4, wherein the calculating the included angle between the first coordinate system and the second coordinate system according to the included angle between the n^{th} time point and the (n−1)^{th} time point of the first coordinate system comprises:
calculating an included angle between an X axis of the first coordinate system and an X axis of the second coordinate system according to a formula αₙ=αₙ₋₁+αₙ₋₂+Λ+α₁; and
calculating an included angle between a Y axis of the first coordinate system and a Y axis of the second coordinate system according to a formula βₙ=βₙ₋₁+βₙ₋₂+Λ+β₁,
where αₙ is an included angle between the X axis of the first coordinate system and the X axis of the second coordinate system at an n^{th} time point, αₙ₋₁ is an included angle between the n^{th} time point and an (n−1)^{th} time point of the X axis of the first coordinate system, αₙ₋₂ is an included angle between the (n−1)^{th} time point and an (n−2)^{th} time point of the X axis of the first coordinate system, and α₁ is an included angle between the X axis of the first coordinate system and the X axis of the second coordinate system at an initial time point; and βₙ is an included angle between the Y axis of the first coordinate system and the Y axis of the second coordinate system at the n^{th} time point, βₙ₋₁ is an included angle between the n^{th} time point and the (n−1)^{th} time point of the Y axis of the first coordinate system, βₙ₋₂ is an included angle between the (n−1)^{th} time point and the (n−2)^{th} time point of the Y axis of the first coordinate system, and β₁ is an included angle between the Y axis of the first coordinate system and the Y axis of the second coordinate system at the initial time point.

6. The method according to claim 1, wherein the calculating a location of the mobile terminal in the second coordinate system according to the acquired acceleration and included angle comprises:
calculating a location of the mobile terminal in the X axis of the second coordinate system according to a formula xₙ=x₋₁+(vx′ₙ₋₁Δt+½axₙ₋₁Δt²)cos αₙ; and
calculating a location of the mobile terminal in the Y axis of the second coordinate system according to a formula yₙ=yₙ₋₁+(vy′ₙ₋₁Δt+½ayₙ₋₁Δt²)cos βₙ,
wherein vx′ₙ₋₁ is calculated according to a formula vx′ₙ₋₁=vx′ₙ₋₂+axₙ₋₂Δt, and vy′ₙ₋₁ is calculated according to a formula vy′ₙ₋₁=vy′ₙ₋₂+ayₙ₋₂Δt,
wherein xₙ is a location of the mobile terminal in the X axis of the second coordinate system at an n^{th} time point, xₙ₋₁ is a location of the mobile terminal in the X axis of the second coordinate system at an (n−1)^{th} time point, vx′ₙ₋₁ is a velocity of the mobile terminal in the X axis of the first coordinate system at the (n−1)^{th} time point, Δt is a time interval between the n^{th} time point and the (n−1)^{th} time point, axₙ₋₁ is an acceleration of the mobile terminal in the X axis of the first coordinate system at the (n−1)^{th} time point, αₙ is an included angle between the X axis of the first coordinate system and the X axis of the second coordinate system at the n^{th} time point, vx′ₙ₋₂ is a velocity of the mobile terminal in the X axis of the first coordinate system at an (n−2)^{th} time point, axₙ₋₂ is an acceleration of the mobile terminal in the X axis of the first coordinate system at the (n−2)^{th} time point, yₙ is a location of the mobile terminal in the Y axis of the second coordinate system at the n^{th} time point, yₙ₋₁ is a location of the mobile terminal in the Y axis of the second coordinate system at the (n−1)^{th} time point, vy′ₙ₋₁ is a velocity of the mobile terminal in the Y axis of the first coordinate system at the (n−1)^{th} time point, ayₙ₋₁ is an acceleration of the mobile terminal in the Y axis of the first coordinate system at the (n−1)^{th} time point, βₙ is an included angle between the Y axis of the first coordinate system and the Y axis of the second coordinate system at the n^{th} time point, vy′ₙ₋₂ is a velocity of the mobile terminal in the Y axis of the first coordinate system at the (n−2)^{th} time point, and ayₙ₋₂ is an acceleration of the mobile terminal in the Y axis of the first coordinate system at the (n−2)^{th} time point.

7. An alarming implementation device, comprising:
an acquisition module, configured to acquire an acceleration of a mobile terminal in a first coordinate system, and acquire an included angle between the first coordinate system and a second coordinate system;
a calculation module, configured to calculate a location of the mobile terminal in the second coordinate system according to the acquired acceleration and included angle; and
an alarming module, configured to make an alarm or send alarm information to a system side apparatus when determining that the calculated location is out of a safety area.

8. The device according to claim 7, further comprising:
a setting module, configured to preset the safety area.

9. The device according to claim 8, wherein the setting module is configured to:
acquire at least three locations of the mobile terminal in the second coordinate system in advance, and connect the acquired locations to form a closed area as the safety area.

10. The device according to claim 7, wherein the acquisition module is configured to:
acquire the acceleration of the mobile terminal in the first coordinate system, and acquire an included angle between an n^{th} time point and an (n−1)^{th} time point of the first coordinate system, where n is an integer greater than or equal to 1; and
calculate the included angle between the first coordinate system and the second coordinate system according to the included angle between the n^{th} time point and the (n−1)^{th} time point of the first coordinate system.

11. The device according to claim 7, wherein the acquisition module is configured to:
acquire the acceleration of the mobile terminal in the first coordinate system, and acquire an included angle between an n^{th} time point and an (n−1)^{th} time point of the first coordinate system, where n is an integer greater than or equal to 1;
calculate an included angle between an X axis of the first coordinate system and an X axis of the second coordinate system according to a formula αₙ=αₙ₋₁+αₙ₋₂+Λ+α₁; and
calculate an included angle between a Y axis of the first coordinate system and a Y axis of the second coordinate system according to a formula βₙ=βₙ₋₁+βₙ₋₂+Λ+β₁,
wherein αₙ is an included angle between the X axis of the first coordinate system and the X axis of the second coordinate system at an n^{th} time point, αₙ₋₁ is an included angle between the n^{th} time point and an (n−1)^{th} time point of the X axis of the first coordinate system, αₙ₋₂is an included angle between the (n−1)^{th} time point and an (n−2)^{th} time point of the X axis of the first coordinate system, and α₁ is an included angle between the X axis of the first coordinate system and the X axis of the second coordinate system at an initial time point; and βₙ is an included angle between the Y axis of the first coordinate system and the Y axis of the second coordinate system at an n^{th} time point, βₙ₋₁ is an included angle between the n^{th} time point and an (n−1)^{th} time point of the Y axis of the first coordinate system, βₙ₋₂ is an included angle between the (n−1)^{th} time point and an (n−2)^{th} time point of the Y axis of the first coordinate system, and β₁ is an included angle between the Y axis of the first coordinate system and the Y axis of the second coordinate system at the initial time point.

12. The device according to claim 7, wherein the calculation module is configured to:
calculate a location of the mobile terminal in the X axis of the second coordinate system according to a formula xₙ=xₙ₋₁+(vx′ₙ₋₁Δt+½axₙ₋₁Δt²)cos αₙ; and
calculate a location of the mobile terminal in the Y axis of the second coordinate system according to a formula yₙ=yₙ₋₁+(vy′ₙ₋₁Δt+½ayₙ₋₁Δt²)cos βₙ,
wherein vx′ₙ₋₁ is calculated according to a formula vx′ₙ₋₁=vx′ₙ₋₂+axₙ₋₂Δt, and vy′ₙ₋₁ is calculated according to a formula vy′ₙ₋₁=vy′ₙ₋₂+ayₙ₋₂Δt,
wherein xₙ is a location of the mobile terminal in the X axis of the second coordinate system at an n^{th} time point, xₙ₋₁ is a location of the mobile terminal in the X axis of the second coordinate system at an (n−1)^{th} time point, vx′ₙ₋₁ is a velocity of the mobile terminal in the X axis of the first coordinate system at the (n−1)^{th} time point, Δt is a time interval between the n^{th} time point and the (n−1)^{th} time point, axₙ₋₁ is an acceleration of the mobile terminal in the X axis of the first coordinate system at the (n−1)^{th} time point, αₙ is an included angle between the X axis of the first coordinate system and the X axis of the second coordinate system at the n^{th} time point, vx′ₙ₋₂ is a velocity of the mobile terminal in the X axis of the first coordinate system at an (n−2)^{th} time point, axₙ₋₂ is an acceleration of the mobile terminal in the X axis of the first coordinate system at the (n−2)^{th} time point, yₙ₋₁ is a location of the mobile terminal in the Y axis of the second coordinate system at the n^{th} time point, yₙ₋₁ is a location of the mobile terminal in the Y axis of the second coordinate system at the (n−1)^{th} time point, vy′ₙ₋₁ is a velocity of the mobile terminal in the Y axis of the first coordinate system at the (n−1)^{th} time point, ayₙ₋₁ is an acceleration of the mobile terminal in the Y axis of the first coordinate system at the (n−1)^{th} time point, βₙ is an included angle between the Y axis of the first coordinate system and the Y axis of the second coordinate system at the n^{th} time point, vy′ₙ₋₂ is a velocity of the mobile terminal in the Y axis of the first coordinate system at the (n−2)^{th} time point, and ayₙ₋₂ is an acceleration of the mobile terminal in the Y axis of the first coordinate system at the (n−2)^{th} time point.

13. An alarming implementation system, comprising:
a mobile terminal, configured to acquire an acceleration of a mobile terminal in a first coordinate system, and acquire an included angle between the first coordinate system and a second coordinate system; calculate a location of the mobile terminal in the second coordinate system according to the acquired acceleration and included angle; and make an alarm or send alarm information to a system side apparatus when determining that the calculated location is out of a safety area; and
the system side apparatus, configured to receive the alarm information from the mobile terminal, and make an alarm.

14. The system according to claim 13, wherein the mobile terminal is further configured to:
preset the safety area.

15. A non-transitory computer-readable storage medium, storing a computer-executable instruction, the computer-executable instruction being used to execute the method according to claim 1.

16. A non-transitory computer-readable storage medium, storing a computer-executable instruction, the computer-executable instruction being used to execute the method according to claim 2.

17. A non-transitory computer-readable storage medium, storing a computer-executable instruction, the computer-executable instruction being used to execute the method according to claim 3.

18. A non-transitory computer-readable storage medium, storing a computer-executable instruction, the computer-executable instruction being used to execute the method according to claim 4.

19. A non-transitory computer-readable storage medium, storing a computer-executable instruction, the computer-executable instruction being used to execute the method according to claim 5.

20. A non-transitory computer-readable storage medium, storing a computer-executable instruction, the computer-executable instruction being used to execute the method according to claim 6.
